(19) United States
(12) Patent Application Publication
(10) Pub. No.: US 2006/0253499 A1
(43) Pub. Date: Nov. 9, 2006

(54) System and method for automatically transferring data from one database to another

(75) Inventor: Feng Zhao, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/302,834

(22) Filed: Dec. 14, 2005

(30) Foreign Application Priority Data
May 6, 2005 (CN) 200510034569.0

(51) Int. Cl. G06F 17/30

(52) U.S. Cl. 707/200

(57) ABSTRACT

A system (1) for transferring data from one database to another database includes a control module (10) and a data transferring module (20). The data transferring module is controlled by the control module, and in one embodiment includes a retrieving module (200), a connecting module (202), an exporting module (204), and a deleting module (210). The data transferring module automatically retrieves data from a first database (5), exports retrieved data to a second database (7), and automatically deletes data that has been retrieved in the first database. A corresponding method for automatically transferring data from one database to another database is also provided.

### BACKGROUND

1. Field of the Invention

The present invention pertains to systems for managing databases, and particularly to systems and methods for transferring data between databases.

2. Related Art

In automatic mass production systems, all data on production lines is saved in a local database. If there are problems with products, managers can check the data in the local database. As the production lines run continuously, the amount of data saved in the local database increases. The capacity of the local database, however, is limited. If there is too much data in the local database, the production lines may be slowed or even come to a halt.

Usually, a manager can transfer historical data in the local database to a remote database, and delete the historical data from the local database to ensure the smooth running of production lines. The manager regularly deletes the historical data manually, by entering a delete command each time. In addition, it is inconvenient and time consuming when only a small amount of data can be deleted each time. Furthermore, the manager may perform this task improperly, causing loss of data. Moreover, the manager must accomplish this task while maintaining his or her watch on the production lines. Any error occurring during data transferring is a possible cause to affect the whole system of the production lines and force slowdown or shutdown of the production lines.

Therefore, a heretofore unaddressed need exists in the industry to overcome the aforementioned deficiencies and inadequacies.

### SUMMARY

An exemplary embodiment of the invention provides a system for automatically transferring data from one database to another database. The system includes a control module and a data transferring module. The control module is used for controlling the data transferring module. The data transferring module is used for automatically retrieving data from a first database, exporting the retrieved data to a second database, and then deleting the transferred data from the first database.

Another embodiment of the invention provides a different system for automatically transferring data from one database to another database. A first database and a second database both include a formal list and a temporary list. The system includes a control module and a data transferring module. The control module is used for controlling the data transferring module. The data transferring module is used for automatically retrieving data from the formal list of the first database, sending the retrieved data to the temporary list of the first database, then exporting the data in the temporary list of the first database to the second database, and then deleting the data retrieved in the first database.

A further embodiment of the invention provides a method for automatically transferring data from one database to another database. The method includes the steps of: retrieving data from a first database; connecting the first database to a second database; exporting retrieved data to the second database; and deleting the retrieved data in the first database.

A still further embodiment of the invention provides a method for automatically transferring data from one database to another database. A first database and a second database both include a formal list and a temporary list. The method includes the steps of: retrieving data from the formal list of the first database, and sending retrieved data to the temporary list of the first database; connecting the first database to the second database; exporting data in the temporary list of the first database to the temporary list of the second database; inserting data in the temporary list of the second database to the formal list of the second database; and deleting the retrieved data in the first database.

Each of the above-described systems and methods automatically transfers data from the first database to the second database, and automatically deletes retrieved data in the first database. Thus each system and method can save manpower and time that would otherwise be spent by a manager on deletion tasks, and is convenient and efficient.

Other advantages and novel features will become more apparent from the following detailed description when taken in conjunction with the accompanying drawings, in which:

### BRIEF DESCRIPTION OF THE DRAWINGS

FIG. 1 is a block diagram of an application environment of a system for transferring data from one database to another according to an exemplary embodiment of the invention;

FIG. 2 is a block diagram of the system for transferring data from one database to another of an embodiment of the invention;

FIG. 3 is a block diagram of the system for transferring data from one database to another of another embodiment of the invention;

FIG. 4 is a flow chart of the method for transferring data from one database to another of an embodiment of the invention; and

FIG. 5 is a flow chart of the method for transferring data from one database to another of another embodiment of the invention.

### DETAILED DESCRIPTION OF THE EMBODIMENTS

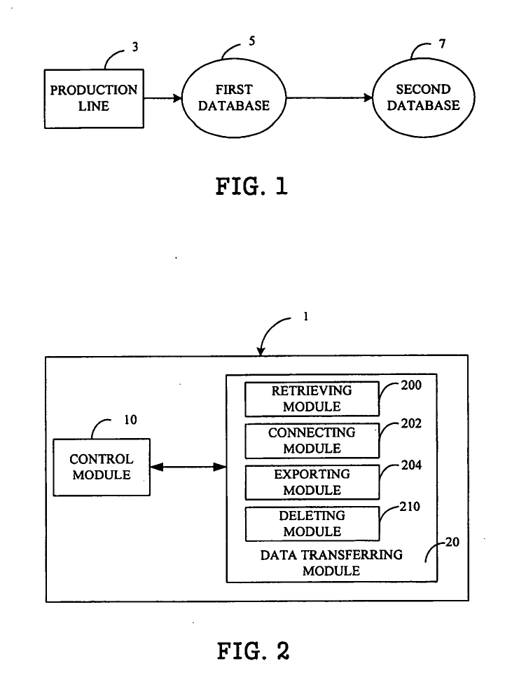

FIG. 1 is a schematic diagram of an operating environment of a system for transferring data from one database to another database according to an exemplary embodiment of the invention. The system runs in servers and databases, and is used for automatically transferring data, especially historical data, from a first database 5 to a second database 7, and automatically deleting transferred data in the first database 5. In the embodiment, the first database 5 is a local database, and is used for saving data on production lines 3. The second database 7 is a remote database. In the embodiment, the system can run on a Structure Query Language (SQL) Server 2000. By use of Data Transformation Service and SQL Server Agent embedded in the SQL Server 2000, and combining saving processes and SQL script, the system automatically transfers historical data from the first database 5 to the second database 7, and then deletes the transferred historical data in the first database 5. Thus, overloading of the first database 5 is avoided, and the production lines 3 can run smoothly. The system saves on manpower and time spent on transferring and deleting, and is convenient and efficient.

FIG. 2 is a block diagram of the system, which is designated with the numeral 1. In the exemplary embodiment, the system 1 is used for transferring data from the first database 5 to the second database 7. In the embodiment, the system 1 includes a control module 10 and a data transferring module 20. The control module 10 is used for controlling the data transferring module 20. In the embodiment, the control module 10 may be the SQL Server Agent. Under control of the control module 10, the data transferring module 20 automatically retrieves data from the first database 5, saves the data that is retrieved from the first database 5 to the second database 7, and then deletes the data that has been retrieved in the first database 5.

In the embodiment, the data transferring module 20 includes a retrieving module 200, a connecting module 202, an exporting module 204, and a deleting module 210. The retrieving module 200 is used for automatically retrieving data from the first database 5 by using an inquiry way of the first database 5. After the retrieving module 200 has finished retrieving data from the first database 5, the connecting module 202 connects the first database 5 to the second database 7 such that the two databases communicate with each other. In another embodiment of the invention, the connecting module 202 is also used for encrypting the connection between the first database 5 and the second database 7. Thus, only specific users can access the connection, thereby strengthening security of the data transfer. After the first database 5 and the second database 7 are connected successfully, the exporting module 204 exports the data retrieved from the first database 5 to the second database 7. After the data retrieved from the first database 5 is successfully saved to the second database 7, the deleting module 210 automatically deletes the data that has been retrieved in the first database 5. In particular, after a predetermined time interval, the deleting module 210 automatically deletes a predetermined amount of the data that has been retrieved in the first database 5. The predetermined time interval and the predetermined amount of data to be deleted can be varied according to need. By setting the time interval and the amount deleted in the system 1, deleting the data that has been retrieved in the first database 5 in one large event is prevented, thereby avoiding the unfavorable influence of a large deleting process on the production lines 3.

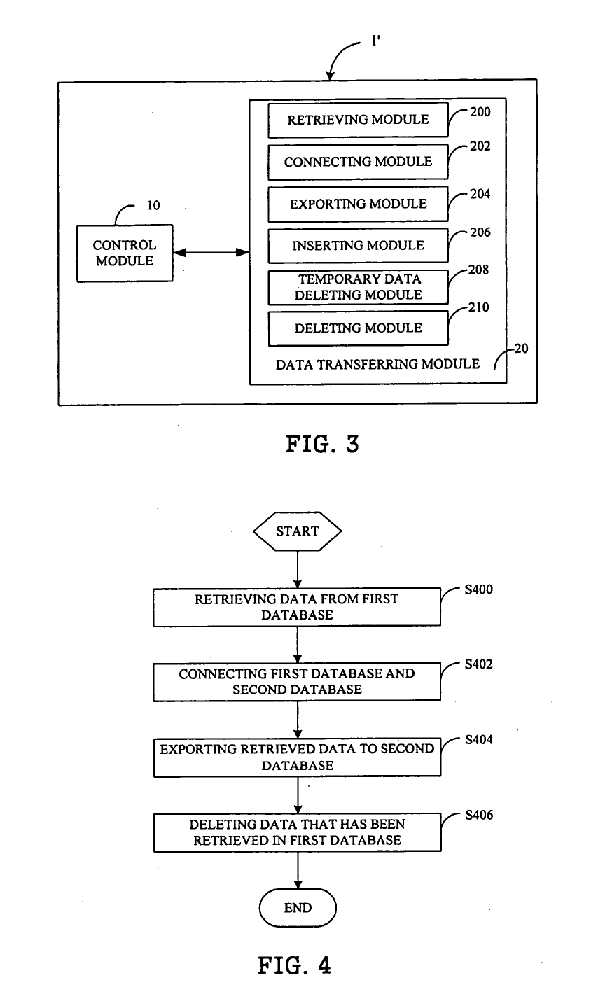

FIG. 3 is a block diagram of the system 1′ for transferring data from a database to another database according to another embodiment of the invention. In the embodiment, the system 1′ is used for transferring data from the first database 5 to the second database 7. The first database 5 and the second database 7 each include a formal list and a temporary list. The formal list of the first database 5 is used for saving data on the production lines 3. The formal list of the second database 7 is used for saving the data transferred from the formal list of the first database 5. The temporary lists of the first database 5 and the second database 7 are both used for saving data temporarily in the data transferring process. In the embodiment, the system 1′ is similar to the above-described system 1, and includes the control module 10 and the data retrieving module 20. The control module 10 is used for controlling the data retrieving module 20. In the embodiment, the control module 10 may be the SQL ServerAgent. Under control of the control module 10, the data transferring module 20 automatically retrieves data from the first database 5, saves the data that has been retrieved from the first database 5 in the second database 7, and then deletes the data that has been retrieved in the first database 5.

The data transferring module 20 includes the retrieving module 200, the connecting module 202, the exporting module 204, and the deleting module 210, and further includes an inserting module 206. In the embodiment, the retrieving module 200 is used for automatically retrieving data from the formal list of the first database 5 by using an inquiry way of the first database 5, and copying the retrieved data to the temporary list of the first database 5. In the embodiment, the amount of data in the temporary list of the first database 5 is less than the amount of data in the formal list of the first database 5. After the retrieving module 200 finishes the retrieval process, the connecting module 202 connects the first database 5 and the second database 7 such that the two databases 5, 7 communicate with each other. In another embodiment, the connecting module 202 is also used for encrypting the connection between the first database 5 and the second database 7. Thus, only specific users can access the connection, thereby strengthening security of the data transfer.

After the first database 5 and the second database 7 are connected successfully, the exporting module 204 exports the data in the temporary list of the first database 5 to the temporary list of the second database 7. After the data in the temporary list of the first database 5 is successfully exported to the temporary list of the second database 7, the inserting module 206 inserts the data in the temporary list of the second database 7 into the formal list of the second database 7. While the inserting module 206 is copying the data in the temporary list of the second database 7 to the formal list of the second database 7, the inserting module 206 automatically detects if there is data in the formal list of the second database 7 that is the same as the data that is waiting for insertion in the temporary list of the second database 7. If the formal list of the second database 7 includes the same data as that waiting for insertion in the temporary list of the second database 7, then the inserting module 206 does not insert that data and checks the next data. If the formal list of the second database 7 does not include the same data as that waiting for insertion in the temporary list of the second database 7, then the inserting module 206 inserts that data. Thereby, no repetition of data in the formal list of the second database 7 is achieved.

After the non-repetitive data in the temporary list of the second database 7 is completely copied to the formal list of the second database 7, the deleting module 210 automatically deletes the data that has been retrieved in the formal list of the first database 5. Moreover, the deleting module 210 is also used for deleting data in the temporary list of the first database 5. Specifically, the deleting module 210 deletes the data in the formal list of the first database 5 according to the data in the temporary list of the first database 5. The deleting module 210 automatically deletes a predetermined amount of the data that has been retrieved in the formal list of the first database 5 and the data in the temporary list of the first database 5 after a predetermined time interval. The predetermined time interval and the predetermined amount deleted can be varied according to need. By setting the time interval and the amount to be deleted in the system 1′, deleting the data that has been retrieved in the first database 5 in one large event is prevented, thereby avoiding the unfavorable influence of a large deleting process on the production lines 3. In the embodiment, the data transferring module 20 also includes a temporary data deleting module 208 for deleting data in the temporary list of the second database 7 when the data in the temporary list of the second database 7 is completely inserted into the formal list of the second database 7. In an alternative embodiment, the temporary data deleting module 208 can be omitted.

FIG. 4 is a flow chart of a method for transferring data from one database to another database according to an exemplary embodiment of the invention. In the embodiment, the method is used for transferring data from the first database 5 to the second database 7. In step S400, under control of the control module 10, the retrieving module 200 of the data transferring module 20 automatically retrieves data from the first database 5 by using an inquiry way of the first database 5. In step S402, after the retrieving module 200 has finished retrieval, the connecting module 202 connects the first database 5 to the second database 7, and encrypts the connection between the first database 5 and the second database 7. In step S404, after the first database 5 and the second database 7 are connected successfully, the exporting module 204 exports the data that has been retrieved from the first database 5 to the second database 7. At this time, the retrieved data exists in the first database 5 and the second database 7. After the exporting module 204 successfully exports the data retrieved from the first database 5 to the second database 7, in step S406, the deleting module 210 automatically deletes a predetermined amount of the data that has been retrieved in the first database 5 after the predetermined time interval. At this time, the retrieved data only exists in the second database 7. Thus, under control of the control module 10, data is automatically transferred from the first database 5 to the second database 7. If there is a mistake in any of the above steps, the corresponding module of the data transferring module 20 that made the mistake notifies the control module 10. Then the control module 10 stops the workflow, and records the mistake in a log. Managers can then check and fix the mistake via the control module 10, and restart the workflow.

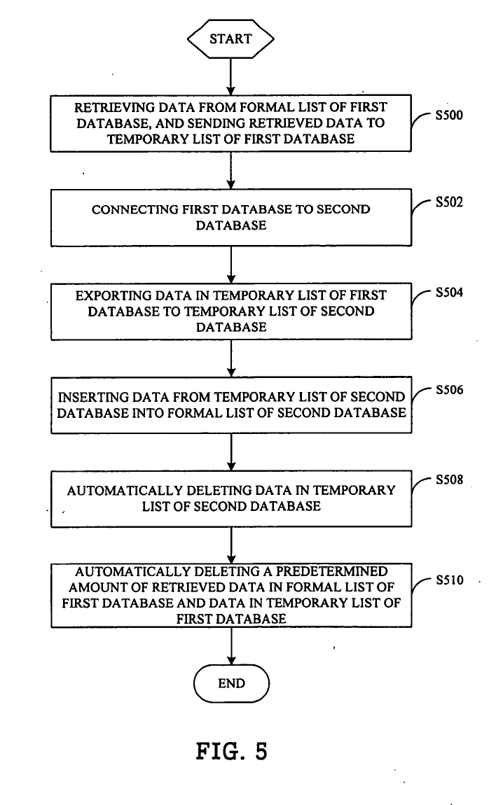

FIG. 5 is a flow chart of a method for transferring data from one database to another database according to another embodiment of the invention. In the embodiment, the first database 5 and the second database 7 each include the formal list and the temporary list, and data is transferred from the formal list of the first database 5 to the formal list of the second database 7 via the following steps. In step S500, under control of the control module 10, the retrieving module 200 of the data transferring module 20 automatically copies data from the formal list of the first database 5 to the temporary list of the first database 5. At this time, the retrieved data exists in both the temporary list and the formal list of the first database 5. In step S502, after the retrieving module 200 finishes retrieval, the connecting module 202 connects the first database 5 to the second database 7, and encrypts the connection between the first database 5 and the second database 7. In step S504, after the first database 5 and the second database 7 are connected successfully, the exporting module 204 exports data in the temporary list of the first database 5 to the temporary list of the second database 7. At this time, the retrieved data exists in the formal list and the temporary list of the first database 5 and the temporary list of the second database 7.

After the exporting module 204 completely exports the data in the temporary list of the first database 5 to the temporary list of the second database 7, in step S506, the inserting module 206 copies the data in the temporary list of the second database 7 to the formal list of the second database 7. During the insertion process, the inserting module 206 automatically detects whether there any data in the formal list of the second database 7 has a duplicate in the temporary list of the second database 7. If the formal list of the second database 7 includes the same data as that waiting for insertion, then the inserting module 206 does not insert the data, and detects the next data. If the formal list of the second database 7 does not include the same data as that waiting for insertion, then the inserting module 206 inserts the data that is waiting. At this time, the retrieved data exists in each of the formal and temporary lists of the first database 5 and the second database 7.

In step S508, when the inserting module 206 successfully inserts the data from the temporary list of the second database 7 to the formal list of the second database 7, the temporary data deleting module 208 automatically deletes the data in the temporary list of the second database 7. At this time, the retrieved data exists in the formal list and temporary list of the first database 5, and in the formal list of the second database 7. In step S510, after the data retrieved from the formal list of the first database 5 is successfully saved in the formal list of the second database 7, the deleting module 210 deletes a predetermined amount of the data that has been retrieved in the formal list of the first database 5 and the data in the temporary list of the first database 7 after a predetermined time interval. The deleting module 210 deletes the data in the formal list of the first database 5 according to the data in the temporary list of the first database 5. At this time, the retrieved data only exists in the formal list of the second database 7. Thus, under control of the control module 10, data is automatically transferred from the formal list of the first database 5 to the formal list of the second database 7. If there is a mistake in any of the above steps, the corresponding module of the data transferring module 20 that made the mistake notifies the control module 10. The control module 10 stops the workflow, and records the mistake in a log. Managers can then check and fix the mistake via the control module 10, and restart the workflow.

With a predetermined operating time and a predetermined retrieval range, the system 1, 1′ and the method can automatically start the transfer of data from the first database 5, and automatically delete the retrieved data. There is no need for manual monitoring. Every step of the method starts after a previous step is successfully completed, thereby avoiding the risk of human error on the part of managers or others. The system 1, 1′ deletes data in the first database 5 after the data is successfully saved in the second database 7, and deletes the data in the formal list of the first database 5 according to the data in the temporary list of the first database 5, thereby avoiding mistaken deletion of data. The amount of data to be deleted can be predetermined in system 1, 1′, thereby reducing or even eliminating any negative impact of operation of the system 1, 1′ on the first database 5 and the production lines 3. By automatically transferring data from the first database 5 to the second database 7, the production lines 3 can run smoothly. The system 1, 1′ and the method for transferring data can also be utilized in banks, supermarkets, airports, websites, and other applications that require a lot of data processing.

While various embodiments have been described above, it should be understood that they have been presented by way of example only and not by way of limitation. Thus the breadth and scope of the present invention should not be limited by the above-described exemplary embodiments, but should be defined only in accordance with the following claims and their equivalents.

I claim:

1. A system for transferring data from one database to another database, comprising:
a control module; and
a data transferring module controlled by the control module, for automatically retrieving data from a first database, exporting retrieved data to a second database, and deleting data that has been retrieved in the first database.

2. The system as recited in claim 1, wherein the data transferring module comprises a retrieving module that is used for retrieving data from the first database.

3. The system as recited in claim 2, wherein the data transferring module comprises a connecting module that is used for connecting the first database to the second database.

4. The system as recited in claim 3, wherein the connecting module is used for encrypting the connection between the first database and the second database.

5. The system as recited in claim 1, wherein the data transferring module comprises an exporting module that is used for exporting the retrieved data to the second database after the first database and the second database are connected successfully.

6. The system as recited in claim 1, wherein the data transferring module comprises a deleting module that is used for automatically deleting the data that has been retrieved in the first database after the retrieved data is transferred to the second database.

7. The system as recited in claim 6, wherein the deleting module deletes a predetermined amount of the data that has been retrieved in the first database after a predetermined time interval.

8. The system as recited in claim 1, wherein the data transferring module is further capable of sending the retrieved data to the temporary list of the first database.

9. The system as recited in claim 8, wherein the data transferring module comprises a retrieving module for retrieving data from the formal list of the first database, and sending the retrieved data to the temporary list of the first database.

10. The system as recited in claim 8, wherein the data transferring module comprises an inserting module for inserting the retrieved data in a temporary list of the second database to a formal list of the second database after the retrieved data is successfully exported to the temporary list of the second database from the temporary list of the first database.

11. The system as recited in claim 10, wherein when the retrieved data in the temporary list of the second database is being inserted into the formal list of second database, the inserting module automatically detects the retrieved data to avoid inserting data that already exists in the formal list of the second database.

12. The system as recited in claim 10, wherein the data transferring module further comprises a temporary data deleting module for deleting the retrieved data in the temporary list of the second database after the retrieved data in the temporary list of the second database is successfully inserted into the formal list of the second database.

13. A method for transferring data from one database to another database, comprising steps of:
retrieving data from a first database;
connecting the first database to a second database;
exporting retrieved data to the second database; and
deleting data that has been retrieved in the first database.

14. The method as recited in claim 13, further comprising the step of encrypting a connection between the first database and the second database after the connecting step.

15. The method as recited in claim 13, wherein a predetermined amount of the data that has been retrieved in the first database is deleted after a predetermined time interval.

16. The method as recited in claim 13, wherein the data is retrieved from a formal list of the first database to a temporary list of the first database, and exported from the temporary list of the first database to a temporary list of the second database.

17. The method as recited in claim 16, further comprising the step of inserting the retrieved data in the temporary list of the second database to a formal list of the second database.

18. The method as recited in claim 16, wherein the deleting step comprises deleting the data that has been retrieved in the formal list of the first database, and deleting the retrieved data in the temporary list of the first database.

19. A method for transferring data between two databases, comprising the steps of:
independently retrieving data from a source database without interrupting other operations on said source database;
connecting said source database to a target database;
transferring said retrieved data from said source database to said target database; and
deleting data of said source database identified as a source of said retrieved data from said source database.

20. The method as recited in claim 19, wherein said retrieved data is acquired from said source database in an inquiry way of said source database.
